(19) United States
(12) Patent Application Publication
(10) Pub. No.: US 2012/0296911 A1
(43) Pub. Date: Nov. 22, 2012

(54) INFORMATION PROCESSING APPARATUS AND METHOD OF PROCESSING DATA FOR AN INFORMATION PROCESSING APPARATUS

(75) Inventors: Sumi Omura, Mitaka-shi (JP); Kentaro Nagahama, Tachikawa-shi (JP); Kensuke Horiuchi, Kunitachi-shi (JP); Takayuki Iida, Tachikawa-shi (JP)

(73) Assignee: KABUSHIKI KAISHA TOSHIBA, Tokyo (JP)

(21) Appl. No.: 13/429,772

(22) Filed: Mar. 26, 2012

(30) Foreign Application Priority Data
May 18, 2011 (JP) 2011-111468

(51) Int. Cl. G06F 17/30

(52) U.S. Cl. 707/740; 707/E17.089

(57) ABSTRACT

According to one embodiment, an information processing apparatus includes a keyword display module, a selection module and an information-retrieval module. The keyword display module is configured to display at least two keywords. The selection module is configured to select a keyword from the at least two keywords displayed by the keyword display module. The information-retrieval module is configured to retrieve information by using the keyword selected by the selection module. The keyword display module is further configured to display one or more keywords belonging to a preset category, as at least one of the at least two keywords.

### CROSS-REFERENCE TO RELATED APPLICATIONS

This application is based upon and claims the benefit of priority from prior Japanese Patent Application No. 2011-111468, filed May 18, 2011, the entire contents of which are incorporated herein by reference.

### FIELD

Embodiments described herein relate generally to a data processing technique suitable for an information processing apparatus that includes the function of using, for example, a browser to review Web pages.

### BACKGROUND

In recent years, various Web sites have come into existence on the Internet. A great number of Web pages are now published on these Web sites. Any end user (hereinafter referred to as a “user”) usually uses a browser, having the home page of any retrieval site (including a portal site providing a retrieval service) displayed on his or her personal computer, and inputs keywords on the home page, retrieving the Web page or pages he or she wants.

More recently, a system has been proposed, which retrieves, from the Internet, information about the Web page a user is reviewing on the browser, thus assisting the user.

The information items the user retrieves from the Internet on the basis of the Web page he or she is reviewing unavoidably belongs to the same category. Further, the information items presented to the user often fall within a narrow range, all belonging to the same category. This is inevitable, because the Web page he or she is viewing has been selected in accordance with his or her taste. Consequently, the system cannot always assist the user to achieve efficient retrieval of Web pages, by presenting the user, for example, the keyword that enable him or her to acquire, for example, unexpected desirable information.

Therefore, a demand exists for a system that efficiently presents a recommendable keyword to the user who is reviewing Web pages.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram showing an outer appearance of an information processing apparatus according to an embodiment.

FIG. 2 is an exemplary block diagram showing a software configuration of the information processing apparatus according to the embodiment, which pertains to a review of Web pages.

FIG. 3 is an exemplary diagram showing a menu that the information processing apparatus according to the embodiment displays while the user is reviewing a Web page.

FIG. 4 is an exemplary diagram showing a basic flow of a spot content display process performed in the information processing apparatus according to the embodiment.

FIG. 5 is an exemplary diagram showing a display screen of the gadget application that operates in the information processing apparatus according to the embodiment.

FIG. 6 is an exemplary diagram showing a keyword list extracted by the information-retrieval support utility that operates in the information processing apparatus according to the embodiment.

FIG. 7 is an exemplary diagram showing a setting of the category of keywords to be arranged, at a predetermined position prior to any other keywords in the keyword list displayed by the gadget application that operates in the information processing apparatus according to the embodiment.

FIG. 8 is an exemplary diagram showing a keyword list displayed by the gadget application that operates in the information processing apparatus according to the embodiment.

### DETAILED DESCRIPTION

Various embodiments will be described hereinafter with reference to the accompanying drawings.

In general, according to one embodiment, an information processing apparatus includes a keyword display module, a selection module and an information-retrieval module. The keyword display module is configured to display at least two keywords. The selection module is configured to select a keyword from the at least two keywords displayed by the keyword display module. The information-retrieval module is configured to retrieve information by using the keyword selected by the selection module. The keyword display module is further configured to display one or more keywords belonging a preset category, as at least one of the at least two keywords.

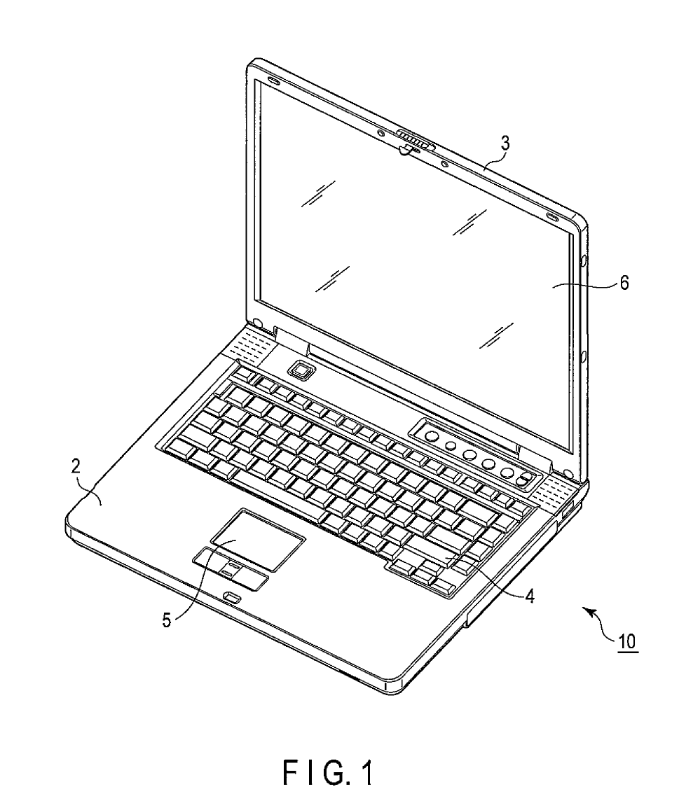

FIG. 1 is an exemplary diagram showing an outer appearance of an information processing apparatus according to an embodiment. The information processing apparatus is implemented as, for example, a battery-powered notebook personal computer 10.

FIG. 1 is an exemplary perspective view showing the computer 10 having its display unit 3 held in an opened position. The computer 10 includes a computer main unit 2 and a display unit 3. The display unit 3 incorporates a liquid crystal display (LCD) 6. The LCD 6 includes a display screen, which is located almost at the center of the display unit 3.

The display unit 3 is secured to the computer main unit 2 and can be freely rotated between an opened position where it exposes the top of the computer main unit 2 and a closed position where it covers the computer main unit 2. The computer main unit 2 is the base unit having a housing shaped like a thin box. On its top, a keyboard 4, and a pointing device 5, etc. are arranged.

The computer main unit 2 incorporates a local area network (LAN) controller and a wireless LAN controller. The LAN controller is configured to perform wired communication that accords with, for example, the IEEE 802.3 Standards. The wireless LAN controller is configured to perform wireless communication that accords with, for example, IEEE 802.11n Standards. That is, the computer 10 includes the function of accessing any Web site on the Internet, no matter whether it is used indoors or outdoors.

The keyboard 4a and the pointing device 5, both shown in FIG. 1, are the input devices at the user interface the computer 10 provides. By contrast, the LCD 6 is the output device at the user interface the computer 10 provides. More specifically, in the computer 10, various programs are loaded from, for example, the hard disk drive (HDD) to the main memory, the central processing unit (CPU) executes these programs in accordance with the instructions the user has input by operating the keyboard 4 or pointing device, and the results of processes performed as the CPU executes the programs are displayed to the user via the LCD 6. Among the programs are the operating system (OS) and the Basic Input/Output System (BIOS), application programs and a utility program. The OS achieves the resource management in the computer 10. The BIOS is used to control the hardware. The application programs include a browser that enables the user to review Web pages.

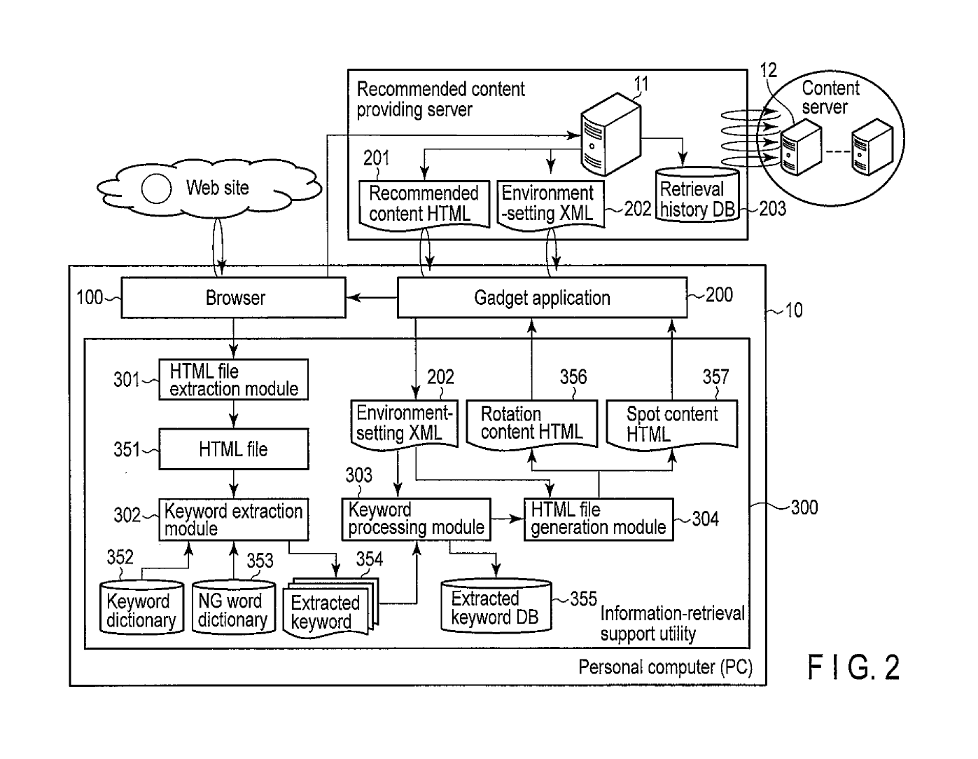

FIG. 2 is an exemplary block diagram showing a software configuration of the computer 10, which pertains to the review of Web pages.

As FIG. 2 shows, the computer 10 includes browser 100, gadget application 200, and information-retrieval support utility 300, as software (programs) related to the Web page reviewing.

The browser 100 is a program that enables the user to review the Web pages any Web site publishes on the Internet. The browser 100 acquires Web pages from a Web site available on the Internet, in accordance with a uniform resource locator (URL) input at, for example, the keyboard 4. The Web pages are written in Hypertext Markup Language (HTML), and are provided as HTML files. The browser 100 interprets any HTML file, reproducing the layout of the Web page. The Web page is displayed on, for example, the screen of the LCD 6. The URL can be embedded in the Web page. The user can therefore input the URL by operating the keyboard 4, and can select the URL embedded in the Web page being displayed, by operating, for example, the pointing device 5. In either case, the URL can be given to the browser 100. The user can therefore continuously review Web pages, from one to another, as if tracking links.

Assume that one of the Web sites available on the Internet is a recommended content providing server 11. The recommended content providing server 11 functions also as a portal site providing retrieval service. In other words, the server 11 functions as a retrieval site. The recommended content providing server 11 receives, from the browser 100, a keyword and attribute data about the keyword, retrieves the Web pages a content server 12 publishes, and sends the results of the retrieval back to the browser 100. The attribute data about the keyword is category (classification) data representing whether the keyword is, for example, a place name or a person name. The content server 12 is one of the Web sites on the Internet.

The gadget application 200 is a program for presenting various data to the user of the computer 10. The information-retrieval support utility 300 is a program that causes the gadget application 200 to present data to the user. In the computer 10 according to this embodiment, the gadget application 200 and the information-retrieval support utility 300 cooperate, efficiently presenting a recommended keyword to the user reviewing the Web page. How the gadget application 200 and the information-retrieval support utility 300 cooperate will be explained below in detail.

As shown in FIG. 2, the information-retrieval support utility 300 includes an HTML file extraction module 301, a keyword extraction module 302, a keyword processing module 303, and an HTML file generation module 304.

The HTML file extraction module 301 is a module configured to extract the Web page, or HTML file the browser 100 is displaying. The HTML file 351 shown in FIG. 2 is an MHML file extracted by the HTML file extraction module 301.

The keyword extraction module 302 is a module configured to perform various processes, such as structure analysis, morpheme analysis and scoring, on the HTML file 351, thereby to extract a keyword from the HTML file 351. The information-retrieval support utility 300 further includes a keyword dictionary 352, an NG word dictionary 353, which the keyword extraction module 302 uses to extract a keyword. The keyword dictionary 352 is used to extract keywords form the text. The NG word dictionary 353 holds the words extracted from the text that should not be used as keywords. Moreover, the information-retrieval support utility 300 includes an extracted keyword dictionary 354, which is a list of the key words the keyword extraction module 302 has extracted from the HTML file 351 and arranged in the order of priority.

The keyword processing module 303 is a module configured to use the keywords 354 extracted by the keyword extraction module 302, generating a keyword list that will be presented to the user. The keyword processing module 303 includes the function of storing keywords 354 extracted, in an extracted keyword database (DB) 355. Therefore, the keyword processing module 303 can not only generated a latest keyword list applicable to the Web page the browser 100 is displaying, but also collect the keywords extracted from the Web pages reviewed in a prescribed past period (e.g., one day, one week, or the like) and generate a keyword list for the predetermined past period.

The HTML file generation module 304 is a module configured to generate HTML files that the gadget application 200 uses to display various data including the keyword list generated by the keyword processing module 303. More precisely, the HTML file generation module 304 generates two HTML files, i.e., a rotation content HTML file 356 and a spot content HTML file 357. The spot content HTML file 357 may be an HTML file that the gadget application 200 uses to display the keyword list the keyword processing module 303 has generated.

The rotation content HTML file 356 is an HTML file that the gadget application 200 uses to display a screen introducing, for example, movies, books recently published, software items recently developed and service items, all recommended to the user. The HTML file generation module 304 acquires a recommended content HTML file 201 from the recommended content providing server 11 through the HTML file the gadget application 200, and generates a rotation content HTML file 356 from the data contained in the recommended content HTML file 201. The rotation content HTML file 356 is so configured that the information to present to the user may be periodically switched.

The recommended content providing server 11 receives many retrieval keywords from the browser 100 and stores these retrieval keywords in a retrieval history data base (DB) 203. In the recommended content providing server 11, the recommended content HTML file 201 stores the keywords collected in the predetermined past period. The HTML file generation module 304 generates a rotation content HTML file 356 so that the result of keyword collection may be displayed to the user as a recommended keyword list.

Thus, the information-retrieval support utility 300 can present to the user three keyword lists, i.e., (1) the latest keyword list extracted from the Web page the browser 100 is displaying, and (2) the keyword list extracted from the Web pages the user has periodically reviewed by virtue of the spot content HTML file 357, and (3) the keyword list that many unidentified users have used for a specific period by virtue of the rotation content HTML file 356. The keyword list (3), which the many unidentified users have used for the specific period, can be presented to the user, also by virtue of the spot content HTML file 357.

The HTML file generation module 304 acquires environment-setting extended markup language (XML) 202 from the recommended content providing server 11 through the gadget application 200. On the basis of the data contained in the environment-setting XML 202, the HTML file generation module 304 sets an environment, setting the timing at which the gadget application 200 displays the rotation content HTML file 356 and the spot content HTML file 357.

Assume that the user operates the pointing device 5, selecting one of the keywords shown in the keyword list, while the spot content HTML file 357 is being displayed. Then, the gadget application 200 supplies the keyword thus selected and the attribute data of the keyword to the browser 100, together with the address data of the recommended content providing server 11, which designates the address to which the keyword and attribute data thereof should be transferred. On receiving the keyword and the attribute data thereof, the browser 100 transfers them to the recommended content providing server 11. The browser 100 then receives and displays the result of retrieval from the recommended content providing server 11.

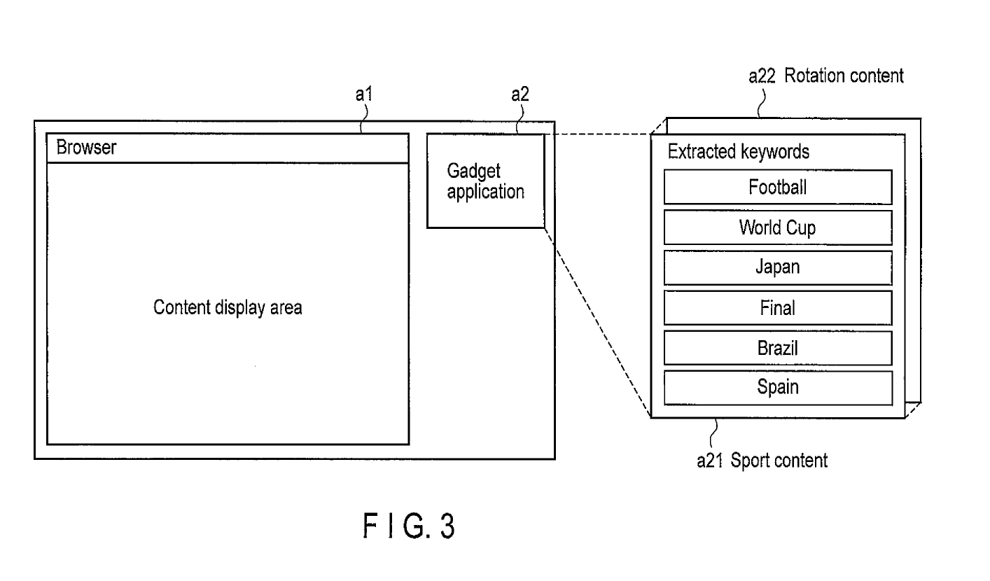

FIG. 3 is an exemplary diagram showing a menu that the information processing apparatus according to the embodiment displays while the user is reviewing a Web page displayed by the display unit 3 of the computer 10.

In FIG. 3, “a1” is the window that the browser 100 provides, and “a2” is the window that the gadget application 200 provides. In window a1, the Web page published at a Web site on the Internet is displayed. In window a2, a spot content a21 or a rotation content a22 is displayed. The spot content a21 is a screen displayed on the basis of the spot content HTML file 357. The rotation content a22 is a screen displayed on the basis of the rotation content HTML file 356.

If the user reviews any Web page by using the browser 100, the gadget application 200 displays the keywords extracted from the Web page the browser 100 is displaying, in the form of a recommended keyword list as shown in FIG. 3. This can help the user to retrieve Web pages more efficiently than otherwise, with an objective point of view. Further, the information-retrieval support utility 300 is configured to select keywords the gadget application 200 will display in the form of a recommended keyword list and to control the arrangement of keywords in this list. How the information-retrieval support utility 300 selects keywords and control the arrangement thereof will be described later.

If the Web page the browser 100 is displaying has a certain attribute for security, the information-retrieval support utility 300 does not extract keywords from the Web page, not presenting a keyword list pertaining to the Web page. If the URL is a Web page starting with, for example, “https://”, this Web page can contain personal data transmitted and received by high-security communication achieved through authentication or encryption. Such a Web page is not subjected to the keyword extraction and the keyword list presentation.

The information-retrieval support utility 300 neither extracts keywords from the Web page being displayed by the browser 100 nor presents a list of keywords pertaining to the Web page if this Web page has been acquired from a file server, not from an HTML server. From which server the Web page has been acquired can be determined in accordance with whether the URL starting with “fts://”.

Moreover, the browser 100 can display not only an HTML file acquired through a network such as the Internet, but also any HTML file stored in, for example, the HDD of the computer 10. This is why the information-retrieval support utility 300 neither extracts keywords nor presents a keyword list if the browser 100 is displays any HTML file stored in the computer 10.

As described above, the information-retrieval support utility 300 acquires the environment-setting XML 202 from the recommended content providing server 11, and sets an environment for the gadget application 200 to display data, in accordance with the data contained in the environment-setting XML 202. The URL, for which keywords need not be extracted or a keyword list need not be represented, can therefore be notified from the recommended content providing server 11 to the information-retrieval support utility 300 of the computer 10. Further, an interface through which the user may input the URL, for which neither keywords need be extracted nor a keyword list need be represented, may be provided in the gadget application 200 or the information-retrieval support utility 300.

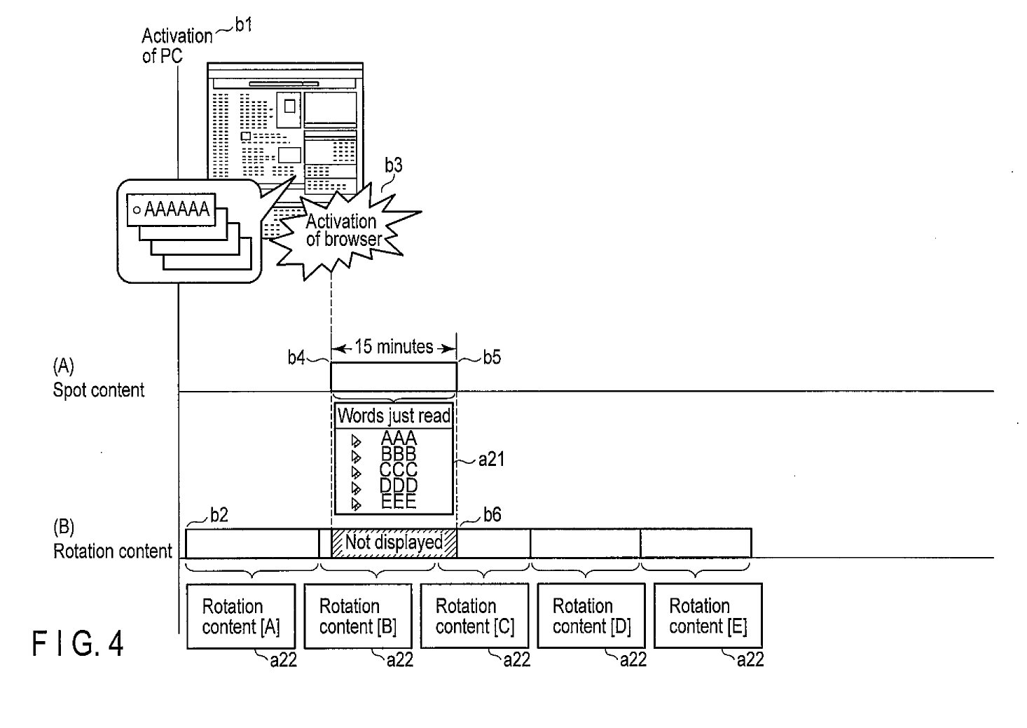

The basic flow of the spot content display process performed in the computer 10 will be explained below, with reference to FIG. 4.

Assume that both the gadget application 200 and the information-retrieval support utility 300 are incorporated as resident programs in the computer 10. Then, when the computer 10 is activated (“b1” in FIG. 4), the window of the gadget application 200 is displayed. By contrast, the browser 100 is activated, as needed, by the user, because the browser 100 is not incorporated as a resident program in the computer. When activated, the information-retrieval support utility 300 first causes the gadget application 200 to display the rotation content (“b2” in FIG. 4).

Now that the browser 100 has been activated, the user starts reviewing the Web page (“b3” in FIG. 4). At this point, the information-retrieval support utility 300 starts displaying a spot content (“b4” in FIG. 4). The gadget application 200 displays rotation content, as an image superimposed on the rotation content. That is, the transition of the rotation content continues on the screen (though not displayed) while the spot content is being displayed.

Every time the browser 100 displays a new Web page, the information-retrieval support utility 300 updates the spot content (more precisely, spot content HTML file 357). The user can therefore see the latest keyword list extracted from the Web page now displayed. If the user finds an interesting keyword in the latest keyword list, he or she selects this keyword in the window of the gadget application window 200. Then, the user can retrieve the information he or she wants, even if he or she cannot track a Web page related to the keyword from the Web page the browser 100 is displaying (because the URL of the Web page related to the keyword is not embedded in the Web page being displayed).

The information-retrieval support utility 300 displays the spot content, only for the period designated by the recommended content providing server 11, that is, for the period represented by the data contained in the environment-setting XML 202. Assume that the period thus prescribed is 15 minutes. Then, upon lapse of 15 minutes from the start of spot content display, the information-retrieval support utility 300 stops displaying the spot content (“b5” in FIG. 4). As a result, the rotation content is displayed again in the window of the gadget application 200 (see “b6” in FIG. 4).

In most cases, the time for which the user may keep interested in the keyword list about the Web page he or she is reviewing is limited (that is, the time the user cannot long keep his mind on the keyword list). Therefore, the content is switched from the spot content to the rotation content when the user seems to lose his or her interest in the key word list. This accomplishes the presentation of useful information.

Hitherto explained is the case where the spot content display is switched to the rotation content display, automatically upon lapse of the period (e.g., 15 minutes) from the start of spot content display, which period is designated by the environment-setting XML 202 acquired from the recommended content providing server 11. Nonetheless, the gadget application 200 may provide a user interface at which the user can instruct that the spot content display be switched to the rotation content display. Then, the content is switched from the spot content to the rotation content in accordance with the user's instruction.

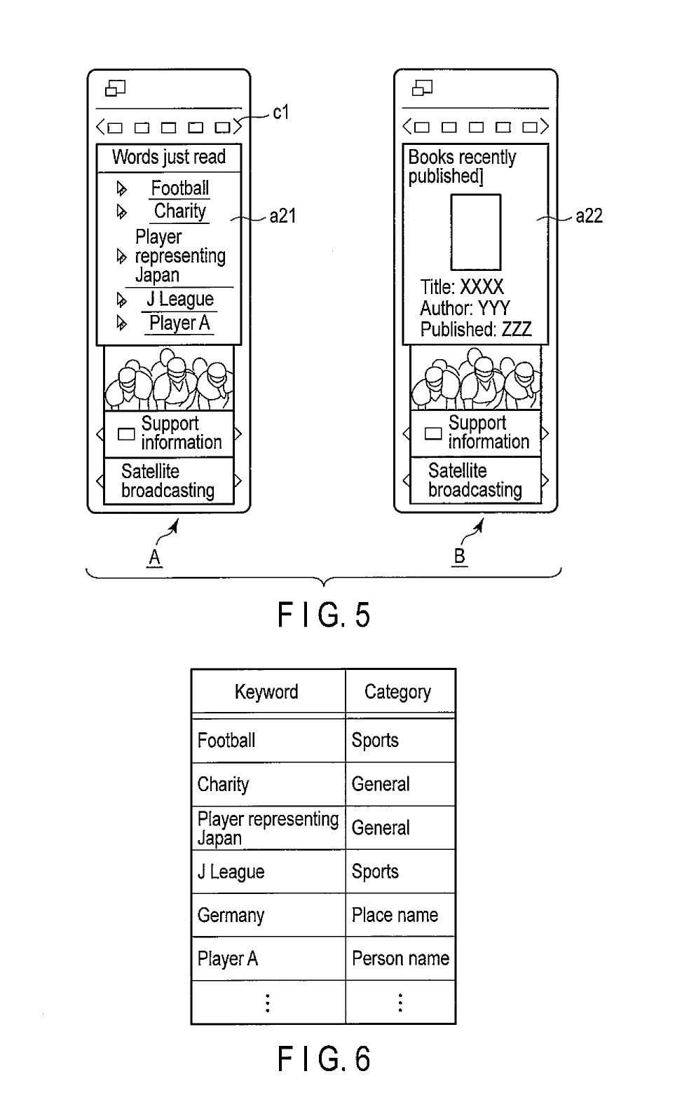

FIG. 5 is an exemplary diagram showing a display screen that may be displayed in window a2 (FIG. 3) of the gadget application 200.

In FIG. 5, “A” is a display screen that the gadget application 200 displays while presenting a spot content a21. On this display screen, objects c1 are displayed above the spot content display area. If the user touches any one of these objects c1, the spot content display is switched to the rotation content display (that is, the spot content display is terminated). In FIG. 5, “B” is a display screen that the gadget application 200 displays while presenting a rotation content a22. On this display screen, objects are displayed above the rotation content display area. If the user touches one of these objects after the spot content display has been automatically terminated, the spot content will be displayed again.

The OS notifies the touching of the object to the gadget application 200. The gadget application 200 in turn notifies the touching to the information-retrieval support utility 300. So notified, the information-retrieval support utility 300 first generates a spot content HTML file 357, as needed, and then instructs the gadget application 200 to switch the spot content (i.e., spot content HTML file 357) to the rotation content (i.e., rotation content HTML file 356), or vice versa.

The principle of the selection of a keyword and control of the keyword arrangement, both related to the spot content displayed in the spot content display process described above, will be explained below.

As described above, in the information-retrieval support utility 300, the HTML file extraction module 301 extracts the Web page (HTML file) that the browser 100 is displaying, and the keyword extraction module 302 performs various processes, such as structure analysis, morpheme analysis and scoring, on the Web page, thereby extracting keywords contained in the Web page. FIG. 6 shows an exemplary keyword list extracted by the keyword extraction module 302 (equivalent to the keywords 354. Assume that keywords “football,” “charity,” “player representing Japan,” “J League,” “Germany,” “player A,”. . . are arranged in the order mentioned (in priority order) as shown in FIG. 6. Added to each of these keywords is attributed data (category data) representing the category the keyword extraction module 302 has determined by analyzing the Web page and to which the keyword belongs.

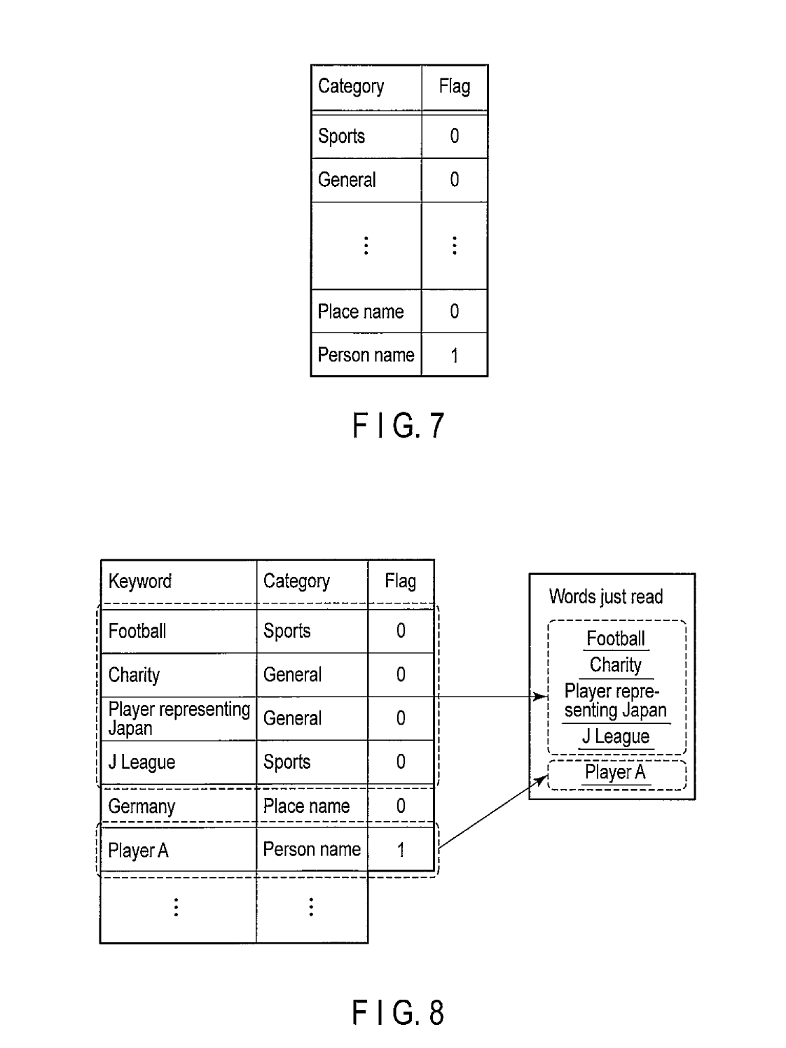

As mentioned above, the information-retrieval support utility 300 acquires the environment-setting XML 202 from the recommended content providing server 11 through the gadget application 200. The environment-setting XML 202 contains data for setting the category of keywords that should be arranged at prescribed positions on the recommended keyword list, which is displayed as a spot content. FIG. 7 is an exemplary diagram showing a setting of the keyword category by using the environment-setting XML 202. As shown in FIG. 7, flags set the priority order in which to arrange keywords in the recommended keyword list, or determine which keyword should be arranged at a prescribed position prior to any other keyword in the recommended keyword list. In this embodiment, a word of category “person name” is set at a prescribed position prior to the keywords of the other categories.

Assume that the five keywords should be arranged in the recommended keyword list displayed as a spot content. In this case, the keyword processing module 303 first acquires, in priority order, five of the keywords extracted by the keyword extraction module 302, and then presents the five keyword extracted. Hence, “football,” “charity,” “player representing Japan,” “J League” and “German” may be selected as five keywords, because they are the first five keywords in the keyword list of FIG. 6.

However, the keyword processing module 303 selects five keywords in a different way since the category is first set, to which belongs the keyword to be arranged prior to the keywords of any other categories in the recommended keyword list to display as spot content. Assume here that the fifth of the five keywords arranged in the recommended keyword list is designated as a keyword of the first category set.

In this case, the keyword processing module 303 first selects four keywords in the priority order from those extracted by the keyword extraction module 302 and then arranges these four keywords in the keyword list. Next, the keyword processing module 303 selects the keyword of the higher priority order than any other remaining keywords, and determines whether the keyword thus selected belongs to the category already set.

In the keyword list of FIG. 6, the fifth keyword to be selected is “Germany” the category of which is “place name.” However, “Germany” is not selected since the category set is “person name” as shown in FIG. 7. The keyword next to “Germany” is “Player A,” whose category is “person name,” i.e., set category. Therefore, “Player A” is selected as fifth keyword, in place of “Germany.” As a result, a keyword list in which “football,” “charity,” “player representing Japan,” “J League” and “Player A” are arranged in the order mentioned is displayed as spot content, as shown in FIG. 8.

The number of keywords belonging to the categories set by using the environment-setting XML 202 and the order in which they are arranged in the keyword list may be set by also using the environment-setting XML 202. Moreover, the fifth keyword in the keyword list may be regarded naturally as having the fifth priority, regardless of its category, if the four keywords selected in priority order from those extracted by the keyword extraction module 302 include a keyword or keywords of the category set by using the environment-setting XML 202.

The environment-setting XML 202 provided by the recommended content providing server 11 can thus control the selection and arrangement of keywords in the recommended keyword list displayed as spot content. Therefore, the gadget application 200 and the information-retrieval support utility 300 present the keywords of the categories interesting to the user, thus achieving an efficient presentation of the keywords extracted from the Web page that the user is reviewing.

In other words, the computer 10 efficiently presents recommended keywords to the user who is reviewing the Web page.

In this embodiment, the control process can be performed by using software (i.e., programs). If the software is installed into an ordinary computer by using a computer-readable storage medium storing the software, the same advantage as that of this embodiment will be easily attained.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a display interface configured to allow for the display of at least two keywords on a display;
a selection module configured to select a keyword from the at least two keywords; and
an information-retrieval module configured to retrieve information by using the keyword selected by the selection module,
wherein the display interface is configured to allow for the display of one or more keywords belonging to a category, as at least one of the at least two keywords.

2. The apparatus of claim 1, further comprising a setting module configured to set the category.

3. The apparatus of claim 2, further comprising a data communication module,
wherein the setting module is configured to receive data representing the category, from an external apparatus through the data communication module.

4. The apparatus of claim 1, further comprising a setting module configured to set an arrangement of the one or more keywords belonging the category in at least two keywords to be displayed by the display.

5. The apparatus of claim 4, further comprising a data communication module,
wherein the setting module is configured to receive data representing the arrangement of the one or more keywords belonging to the category, from an external apparatus through the data communication module.

6. The apparatus of claim 1, further comprising a keyword extraction module configured to extract keywords from a file containing text data,
wherein the display interface is configured to allow for the display of keywords extracted by the keyword extraction module.

7. The apparatus of claim 6, wherein the keyword extraction module is configured to extract keywords from a hypertext markup language (HTML) file displayed by a browser.

8. A method of processing data for an information processing apparatus which retrieves information by using a keyword selected from at least two displayed keywords, the method comprising:
displaying one or more keywords belonging to a category, as at least one of the at least two keywords.

9. The method of claim 8, further comprising setting the category.

10. The method of claim 9, wherein the setting the category comprises receiving data representing the category from an external apparatus through a data communication interface.

11. The method of claim 8, further comprising setting an arrangement of the one or more keywords belonging the category in at least two keywords to be displayed.

12. The method of claim 11, wherein setting the arrangement comprises receiving data representing the arrangement of the one or more keywords belonging to the category, from an external apparatus through a data communication interface.

13. The method of claim 8, further comprising extracting keywords from a file containing text data, wherein displaying the at least two keywords comprises displaying the extracted keywords.

14. The method of claim 13, wherein extracting keywords comprises extracting keywords from a hypertext markup language (HTML) file displayed by a browser.
